(19) United States
(12) Patent Application Publication
(10) Pub. No.: US 2005/0105638 A1
(43) Pub. Date: May 19, 2005

(54) Method and apparatus for performing modulation/demodulation in a wireless communication system

(76) Inventors: Henry Spyker Owen, Medford, NJ (US); Chad Michael Hawes, Burlington, NJ (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(21) Appl. No.: 10/948,994

(22) Filed: Sep. 24, 2004

Related U.S. Application Data
(60) Provisional application No. 60/505,506, filed on Sep. 24, 2003.

(51) Int. Cl. H04L 27/04

(52) U.S. Cl. 375/295

(57) ABSTRACT

A method and apparatus for processing a data symbol is described. In one embodiment, the data symbol is modulated to produce a modulated data symbol. The modulated data symbol is encoded to generate an embedded offset in the modulated data symbol. The modulated data symbol is then transmitted with the embedded offset. In another embodiment, a modulated signal having an embedded offset is received. A symbol estimate is derived from the modulated signal. The symbol estimate is then applied to demodulate the modulated signal.

### CROSS-REFERENCE TO RELATED APPLICATIONS

This application claims benefit of U.S. provisional patent application Ser. No. 60/505,506, filed Sep. 24, 2003, which is herein incorporated by reference.

### BACKGROUND OF THE INVENTION

Embodiments of the present invention generally relate to a method for modulating and demodulating wireless communication packets that use a coded sequence, e.g., a preamble sequence to aid detection. In wireless communications, packets of information are transmitted and received. A preamble sequence is often placed in front of the transmitted packet so that a receiver will be able to recognize the preamble sequence and perceive that a packet has been received. Many wireless communications systems us a direct sequence spread spectrum (DSSS) scheme for the purposes of modulating a data symbol. A typical spread symbol sequence may be given as
p[k]=[p₁, p₂, p₃, . . . , pₖ₋₁, pₖ]. (EQU. 1)

There are a number of means for encoding a preamble sequence and detecting the preamble sequence at the receiver side. One is called coherent integration. The other is called non-coherent integration. In coherent integration, a filter is applied where every single tap of the filter matches every single element of the preamble sequence. This technique is subject to degradation in the presence of Doppler shifts and dynamic multipath but gives the best peak gain. This technique is applicable to both packet detection and symbol demodulation. An example of a matched filter may be given as
h[k]=[pₖ*, pₖ₋₁*, . . . , p₃*. p₂*, p₁*]. (EQU. 2)

When there exists a frequency offset in the received signal after conversion to a frequency appropriate for correlation processing, or when the channel amplitude and phase characteristics vary over the time period of the preamble, the detection filter is no longer matched so that there is a significant signal-to-noise ratio (SNR) loss. To address this SNR loss, current methods include separating the preamble sequence into segments or subsymbols, where ideal matched filtering is performed on one or more segments and the resulting real magnitudes or squares of magnitudes are added together. The use of ideal matched filtering on segments of the preamble is known as non-coherent integration. However, non-coherent integration suffers from processing loss relative to an ideal matched filter, and has limited applicability to the function of demodulating a symbol.

Therefore, there is a need in the art for a wireless communications modulation/demodulation method that is resistant to degradation caused by frequency shifts and is resistant to degradation caused by limited channel coherency.

### SUMMARY OF THE INVENTION

The present invention generally describes a method and apparatus for processing a data symbol. In one embodiment, the data symbol is modulated to produce a modulated data symbol. The modulated data symbol is encoded to generate an embedded offset in the modulated data symbol. The modulated data symbol is then transmitted with the embedded offset.

In another embodiment, a modulated signal having an embedded offset is received. A symbol estimate is derived from the modulated signal. The symbol estimate is then applied to demodulate the modulated signal.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a transmitter/receiver system in accordance with one embodiment of the present invention;

FIG. 2 illustrates an example of a received signal in accordance with one embodiment of the present invention;

FIG. 3 illustrates an example of a symbol in accordance with one embodiment of the present invention;

FIG. 4 illustrates a diagram of a method in accordance with one embodiment of the present invention;

FIG. 5 illustrates an example of encoding a modulated symbol to generate an embedded offset in accordance with one embodiment of the present invention;

FIG. 6 illustrates a diagram of a method in accordance with one embodiment of the present invention;

FIG. 7 illustrates an example of deriving a symbol estimate in accordance with one embodiment of the present invention;

FIG. 8 illustrates an example of deriving a symbol estimate in accordance with one embodiment of the present invention; and

FIG. 9 illustrates a block diagram of communication signal processing device or system in accordance with one embodiment of the present invention.

### DETAILED DESCRIPTION

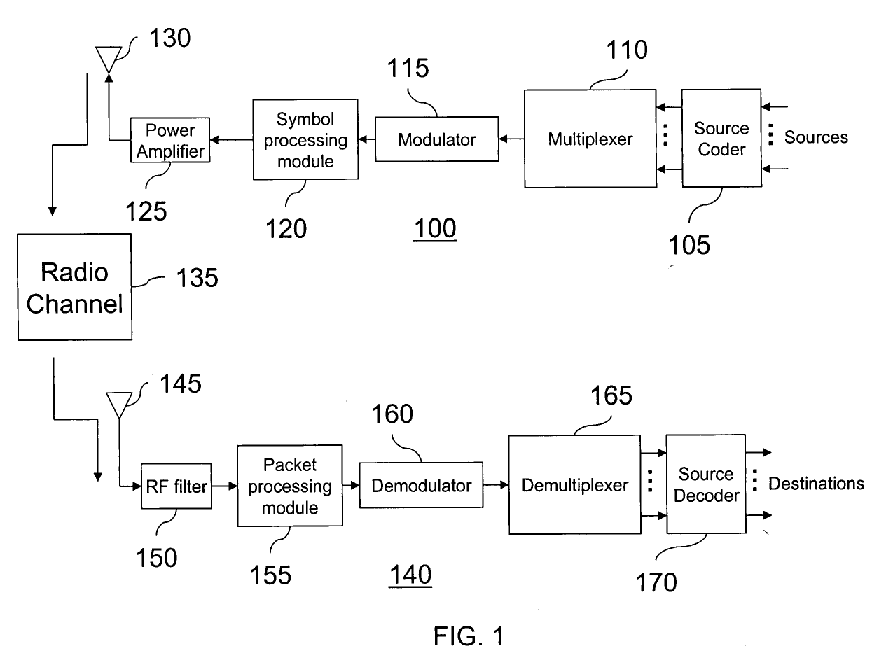

FIG. 1 illustrates a typical transmitter/receiver system 100,140 in accordance with one embodiment of the present invention. Referring to transmitter 100, a plurality of source signals is encoded using source coder 105. The encoded signals are multiplexed via multiplexer 110 and modulated by modulator 115. In one embodiment, modulator 115 utilizes a DSSS scheme. A first symbol processing module 120 embeds an offset into the modulated signal. It should be apparent to one having skill in the art that the first symbol processing module may also be implemented in modulator 115. Once the modulated signal is processed by symbol processing module 120, the signal is amplified and transmitted via radio channel 135.

Referring to receiver 140, a signal is received at antenna 145 via radio channel 135. The signal received at antenna 145 may be a signal having a preamble sequence and a payload. The payload may contain at least one packet. Filtering is performed at RF filter 150. RF filter 150 may be a matched filter, e.g., a sliding correlator. A second symbol processing module 155 derives a symbol estimate from the modulated signal. The signal is then demodulated by applying the symbol estimate prior to demodulation by demodulator 160. It should be apparent to one having skill in the art that the second symbol processing module 155 may also be implemented in demodulator 160. Once the signal is demodulated, the demodulated signal is routed to source decoder 170 via demultiplexer 165, where the demodulated signal is further decoded.

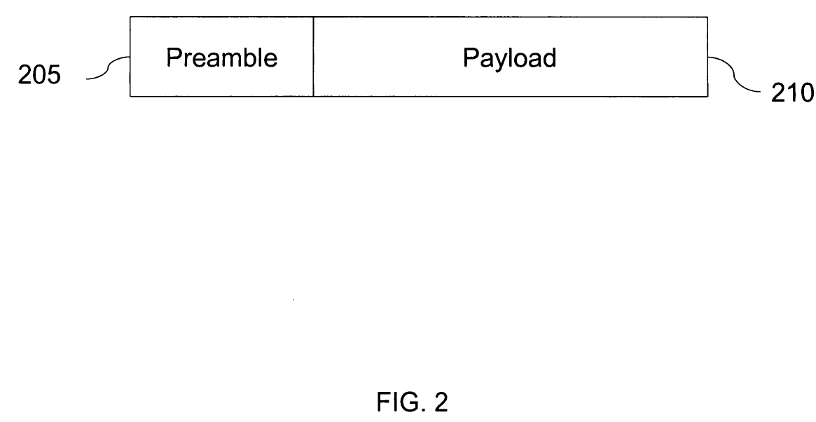

FIG. 2 illustrates an example of a signal, e.g., a random access burst. The signal may be transmitted by transmitter 100 and received by receiver 140. In one embodiment, the random access burst comprises a symbol, e.g., preamble sequence 205 and a payload 210. Payload 210 may comprise a user packet, cyclic redundancy check (CRC), or other information. Many wireless communications systems use a training signal, often as a preamble or midamble to a packet, for the purposes of packet detection and synchronization. Such a preamble sequence comprises a sequence of known chips, symbols, or pulses that provides a reference for a detection method. An optimum detector for a preamble, in the presence of Gaussian noise, is a matched filter. The use of a matched filter to detect a preamble is regarded as coherent integration. In one embodiment, the matched filter may be a sliding correlator.

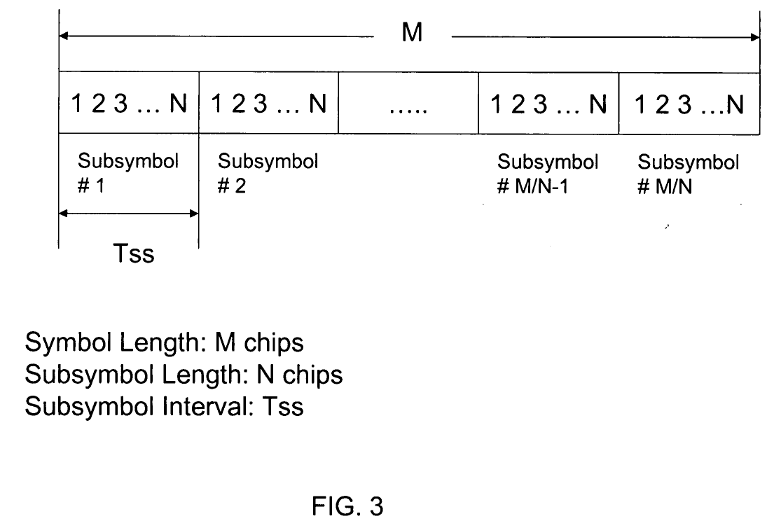

One example of a symbol is shown in FIG. 3. A symbol transmitted by transmitter 100 and received by receiver 140 may be given as
x[M]=[x₁, x₂, x₃, . . . , x_{M-1}, x_{M}]. (EQU. 3)
The symbol of this embodiment has a length of M chips, separated into subsymbols. Each of the subsymbols has a length N. The “chips” of the symbol can be real or complex modulated values, or separate pulses characterized by a timing offset or phase and amplitude variations.

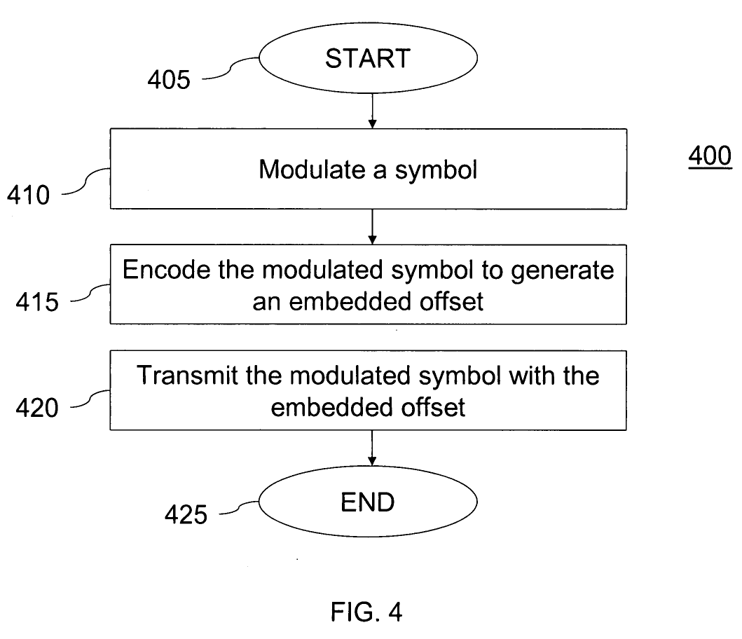

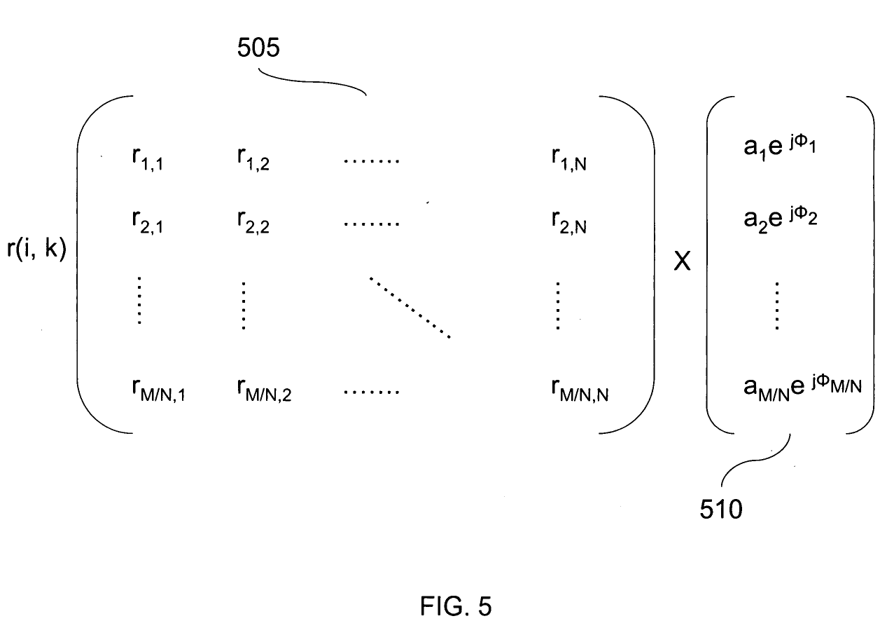

FIG. 4 illustrates a diagram of a symbol processing method according to one embodiment of the present invention. Method 400 starts at step 405 and proceeds to step 410. In step 410, a symbol is modulated to produce a modulated symbol. In step 415, the modulated symbol is encoded to generate an embedded offset in the modulated symbol. This method is illustrated in FIG. 5.

FIG. 5 illustrates an example of encoding a modulated symbol to generate an embedded offset. The modulated data, r(i, k), e.g., a spread data sequence, is represented by a N×M/N matrix 505 where M is the length of the modulated symbol and N is the number of subsymbols. Matrix 505 is encoded with an embedded offset represented by 1×M/N matrix 510. The encoding of a spread data sequence may be characterized by
s(i, k)=r(i, k)×aᵢe^{jΦ}^{ᵢ} (EQU. 4)
where k equals the chip number in the subsymbol, i equals the subsymbol number, aᵢ and Φᵢ are subsymbol encoding values and r(i, k) is the spread data sequence.

Returning to FIG. 4, in step 420, the modulated symbol is transmitted with the embedded offset. Method 400 ends in step 425.

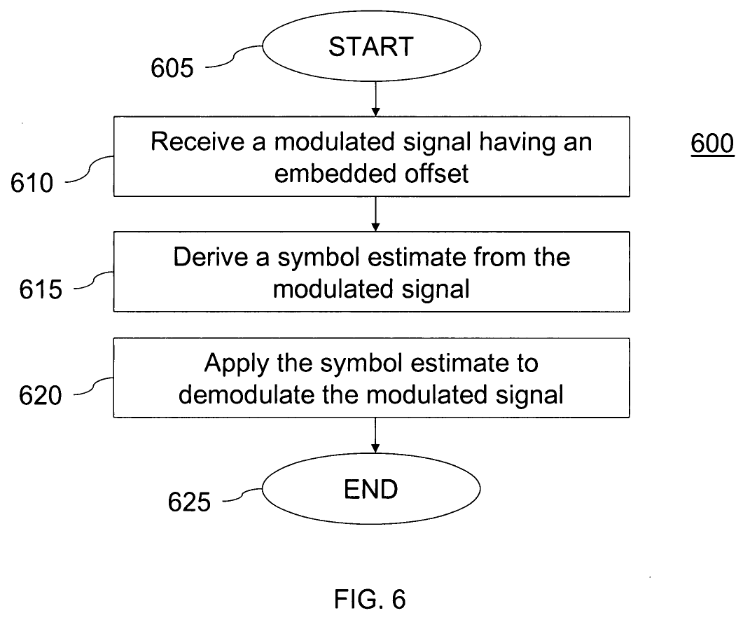

FIG. 6 illustrates a diagram of a demodulation method according to one embodiment of the present invention. Method 600 starts at step 605 and proceeds to step 610. In step 610, a modulated signal having an embedded offset is received.

In step 615, a symbol estimate is derived from the modulated signal in two steps. First, a matched filter is applied for each of the M/N subsymbols. The output of the matched filter y(l) for the M/N subsymbols may be characterized as

$$y ( l ) = {\sum }_{k = ( l - 1 ) N + 1}^{lN} x [ k ] {h}_{1} [ REM ( k / N ) ] \qquad ( EQU . 5 )$$

where x[k] represents the received samples of the encoded signal and hₗ[ ] represents the matched filter for the spreading sequence and l=1 to M/N. REM in EQU. 4 means “remainder of.”

Then a symbol estimate is determined. In one embodiment, the symbol estimate may be characterized as:

$$\hat{s} = {\sum }_{l = 1}^{M / N - 1} y [ l ] \times {y}^{*} [ l + 1 ] \qquad ( EQU . 6 )$$

where ŝ represents the summation from l=1 to M/N−1 of the product of the output of the matched filter for a subsymbol, y[l], with the conjugate of the output for the next subsymbol, y*[l+1]. The symbol estimate is complex, comprising a magnitude and phase. The symbol estimate is an estimate of the autocorrelation of the subsymbols, estimated at one lag, e.g., one subsymbol offset. The lag is set based on the width of the subsymbol.

The width of the subsymbol is set based on the type of application and the system constraints involved in each specific application. In one illustrative embodiment, M=8 and N=1024 with a chip rate of 8 MChips/sec.

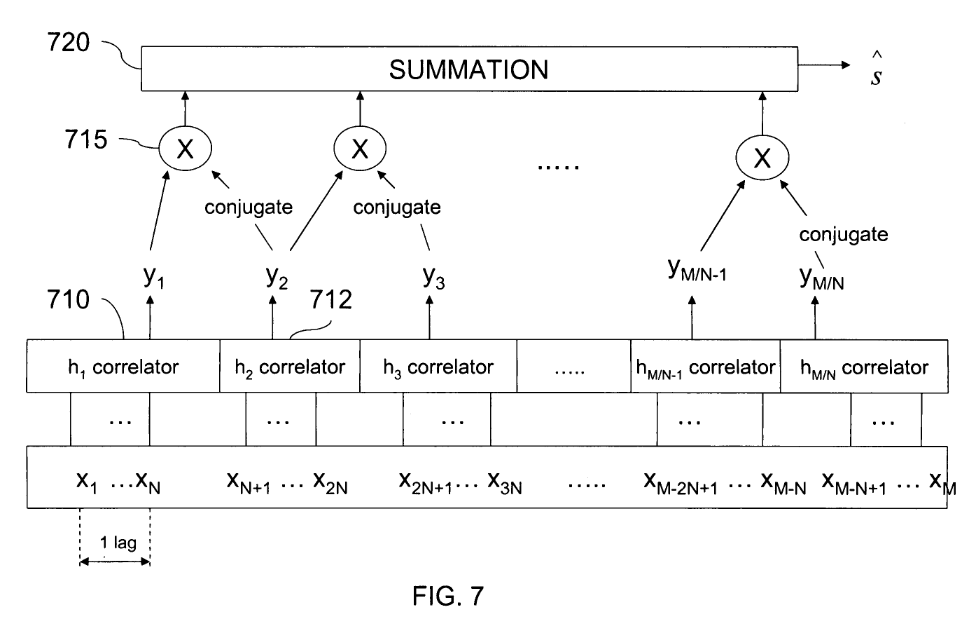

FIG. 7 illustrates an example of deriving a symbol estimate for a known embedded offset according to one embodiment of the present invention. A matched filter is applied to each subsymbol x₁, . . . , x_{N}; x_{N+1}, . . . , x_{2N}; x_{2N+1}, . . . , x_{3N}; . . . ; x_{M-2N+1}, . . . , x_{M-N}; x_{M-N+1}, . . . , x_{M}. The output, e.g., y1, from a matched filter 610 of a current subsymbol is then multiplied by the conjugate of the output, e.g., y2, of matched filter 612 of a subsequent subsymbol, using multiplier 615. This operation is repeated for each subsymbol. The symbol estimate is provided at one lag since an approximate symbol estimate is not provided for the first subsymbol. It should be noted that for each product of the output of the matched filter for a current subsymbol and the conjugate of the output of the matched filter for a subsequent subsymbol, an approximation of the symbol estimate is provided. The output from each multiplier, i.e., an approximate symbol estimate, is summed by summer 620 to provide the symbol estimate.

Thus, the present invention applies an autocorrelation across subsymbols to determine a symbol estimate. In one embodiment, the output of the autocorrelation is complex. For example, a phase of the output of the autocorrelation may be used as a symbol estimate.

Returning to FIG. 6, in step 620, the symbol estimate is applied to demodulate the modulated signal. Since the output of the autocorrelation, i.e., the symbol estimate, is complex, magnitude and phase information is available. Embedded in the phase information is an estimate of the frequency mismatch in the channel which allows for correction of the symbol. Also embedded in the phase information is the embedded offset that was encoded in the modulated symbol from transmitter 100. The phase of the autocorrelation estimate provides information regarding the estimated frequency offset of the received signal. The frequency offset, \hat{f}, estimator may be characterized as

$$\hat{f} = - \frac{1}{{T}_{ss}} \frac{∠ \hat{ s}}{2 π} conj [ ∠ s ] \qquad ( EQU . 7 )$$

where Tₛₛ is the symbol period and ∠ŝ is the phase information. Multiplying by the conjugate of ∠s accounts for the symbol information phase offset that was encoded into the signal at transmitter 100, as determined by a ‘slicer’ function in the demodulator. Therefore, \hat{f} substantially reflects the offset caused by distortion of the signal, e.g., multipath distortion, and provides a more accurate frequency offset estimation. This frequency offset estimation can be used to correct subsequent subsymbols before demodulation. This correction is accomplished by using corrected chip data, z′[k]. In one embodiment, the corrected chip data may be characterized as
z′[k]=z[k]e^{-j2π\hat{f}T}^{_{c}}^{k} (EQU. 8)
where z[k] is the received chip data, \hat{f} is the frequency offset, T_{c} is the length of the chip interval, and k is the chip count.

In one embodiment, once the corrected symbol data, e.g., corrected data for each chip of the symbol, is obtained, a new symbol estimate is derived using the corrected symbol data. The method is identical to the example disclosed in FIG. 7 except that a matched filter is applied to each subsymbol x′₁, . . . , x′_{N}; x′_{N+1}, . . . , x′_{2N}; x′_{2N+1}, . . . , x′_{3N}; . . . ; x′_{M-2N+1}, . . . , x′_{M-N}; x′_{M-N+1}, . . . , x′_{M}. The output from a matched filter of a current subsymbol is then multiplied by the conjugate of the output of matched filter of a subsequent subsymbol, using a multiplier. This operation is repeated for each subsymbol. This embodiment would be considered a chip level correction. The new symbol estimate is provided at one lag since an approximated symbol estimate is not provided for the first subsymbol. It should be noted that for each product of the output of the matched filter for a current subsymbol and the conjugate of the output of the matched filter for a subsequent subsymbol, an approximation of the new symbol estimate is provided. The output from each multiplier, i.e., an approximate symbol estimate, is summed to provide the new symbol estimate.

In one embodiment, a subsymbol level correction would be made in order to derive a new symbol estimate. In this embodiment, instead of obtaining a corrected value for each chip, the correction would be applied to the output of each correlator [y₁, y₂, . . . , y_{M/N}] in order to obtain corrected values for each correlator output. In this embodiment, the corrected correlator output values (and their conjugates) would be applied to the multipliers in FIG. 7. The corrected correlator output data may be characterized as:
y′[k]=y[k]e^{j2π\hat{f}T}^{ₛₛ}^{k} (EQU. 9)
where y[k] is the correlator output data, \hat{f} is the frequency offset, Tₛₛ is the length of the subsymbol interval, and k is the subsymbol count.

In one embodiment, once the frequency offset estimation is obtained via the approach of FIG. 7 a further refinement or correction received data for near full coherent demodulation performed. In this embodiment, a symbol value is encoded in the first subsymbol. The first subsymbol value, i.e. y₁ of EQU. 10, may be a constant or a generic reference value that is selected in accordance with design constraints of the system. Subsequent subsymbols are calculated by generating values related to the previous value with an approximate symbol estimate equal to the absolute value of the first subsymbol (e.g., if the first subsymbol is

$$\{ \frac{1}{\sqrt{2}} ( 1 + j ) \} ,$$

then the next subsymbol is {j}, and the third is

$$\{ \frac{1}{\sqrt{2}} ( - 1 + j ) \} .$$

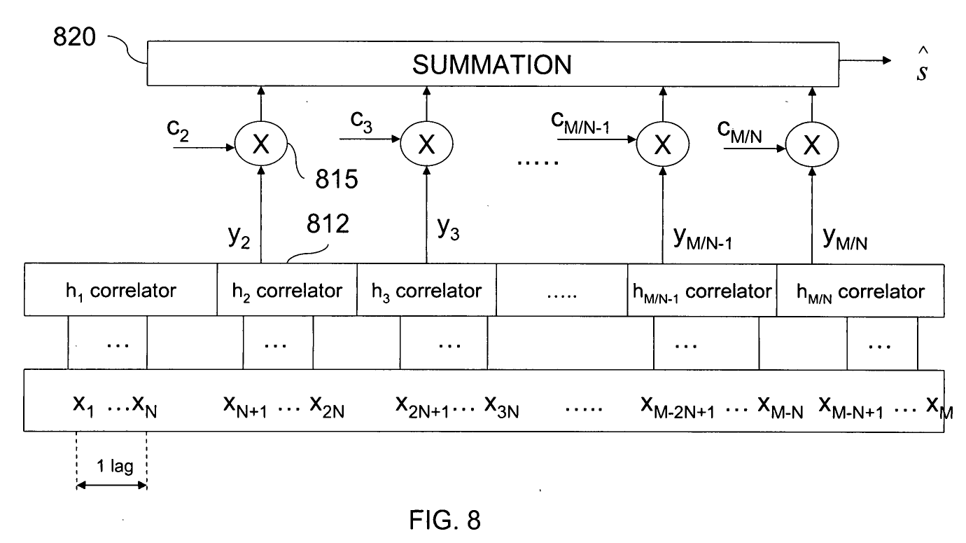

Thus, each subsymbol is corrected based on information from the previous subsymbol. This encoding process may be characterized as
yₗ=y₁×[y₁^{l-1} (EQU. 10)
where y₁ is a symbol value and i=[2, 3, . . . , M/N] The subsequent correction approach for obtaining near full coherent integration is shown in FIG. 8.

FIG. 8 illustrates an example of refining data for full coherent demodulation according to one embodiment of the present invention. A matched filter is applied to each subsymbol x₁, . . . , x_{N}; x_{N+1}, . . . , x_{2N}; x_{2N+1}, . . . , x_{3N}; . . . ; x_{M-2N+1}, . . . , x_{M-N}; x_{M-N+1}, . . . , x_{M}. The output, e.g., y2, from a matched filter 810 of a current subsymbol is then multiplied by a correction factor, e.g., c2, using multiplier 815. This operation is repeated for each subsymbol. The symbol estimate is provided at one lag since an approximated symbol estimate is not provided for the first subsymbol. It should be noted that for each product of the output of the matched filter for a current subsymbol and the correction factor, an approximation of the symbol estimate is provided. The output from each multiplier, i.e., an approximate symbol estimate, is summed by summer 820 to provide the symbol estimate.

In one embodiment, the method used to derive the correction factor depends on the level at which a previous correction (using the method of FIG. 7) was made. If the previous correction was a chip level correction, the correction factor would be characterized as
cₗ={conj[E[yₗyₗ₊₁*]]}^{l} (EQU. 11)
where EQU. 10 provides the values for yₗ, l is the subsymbol index and E is the expected value.

If the previous correction was a subsymbol level correction, the correction factor would be characterized as
cₗ=e^{-j2π\hat{f}T}^{ₛₛ}^{l}}conj[E[yₗyₗ₊₁]]}ⁱ (EQU. 12)
where Tss is the subsymbol interval, l is the subsymbol index, E is the expected value and EQU. 10 provides the values for y_{l,}.

The present invention is resistant not only to frequency offsets in a received packet, but also to channel coherence limits. As long as the channel is coherent for one subsymbol interval (less than one symbol interval), the present invention is effective.

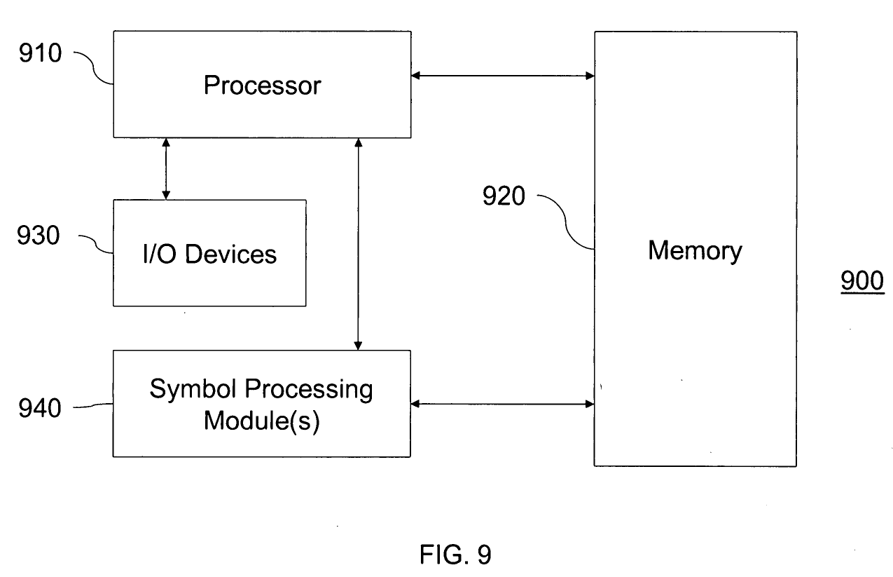

FIG. 9 illustrates a block diagram of communication signal processing device or system 900 of the present invention. Specifically, the system can be employed to process a symbol either after modulation in a transmitter or before demodulation in a receiver. In one embodiment, the communication signal processing device or system 900 is implemented using a general purpose computer or any other hardware equivalents.

Thus, communication signal processing device or system 900 comprises a processor (CPU) 910, a memory 920, e.g., random access memory (RAM) and/or read only memory (ROM), symbol processing module 940, and various input/output devices 930, (e.g., storage devices, including but not limited to, a tape drive, a floppy drive, a hard disk drive or a compact disk drive, a receiver, a transmitter, a speaker, A/D and D/A converters.

It should be understood that the symbol processing module 940 can be implemented as one or more physical devices that are coupled to the CPU 910 through a communication channel. Alternatively, the symbol processing module 940 can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 920 of the computer. As such, the symbol processing module 940 (including associated data structures) of the present invention can be stored on a computer readable medium, e g., RAM memory, magnetic or optical drive or diskette and the like.

While the foregoing is directed to embodiments of the present invention, other and further embodiments of the invention may be devised without departing from the basic scope thereof, and the scope thereof is determined by the claims that follow.

1. A method for processing a data symbol, comprising:
modulating the data symbol to produce a modulated data symbol;
encoding the modulated data symbol to generate an embedded offset in said modulated data symbol; and
transmitting the modulated data symbol with said embedded offset.

2. The method of claim 1, wherein the modulated symbol is a spread data symbol.

3. The method of claim 2, wherein the spread data symbol is represented by a matrix.

4. The method of claim 1, wherein the transmitted modulated data symbol is characterized by
s(i, k)=r(i, k)×aᵢe^{jΦ}^{ᵢ}
where k equals the chip number in the subsymbol, i equals the subsymbol number, aᵢ and Φᵢ are subsymbol encoding values and r(i, k) is the spread data sequence.

5. A method for demodulating a signal, comprising:
receiving a modulated signal having an embedded offset;
deriving a symbol estimate from the modulated signal; and
applying the symbol estimate to demodulate the modulated signal.

6. The method of claim 5, further comprising:
removing the embedded offset from said symbol estimate; and
generating a new symbol estimate.

7. The method of claim 6, wherein generating a new symbol estimate comprises:
obtaining corrected symbol data;
applying a matched filter to each subsymbol of said corrected symbol data, where said corrected symbol data comprises a plurality of subsymbols;
generating a plurality of approximate symbol estimates; and
summing the plurality of approximate symbol estimates to derive the new symbol estimate.

8. The method of claim 6, wherein generating a new symbol estimate comprises:
obtaining corrected symbol data where said corrected symbol data comprises a plurality of subsymbols;
generating a plurality of approximate symbol estimates; and
summing the plurality of approximate symbol estimates to derive the new symbol estimate.

9. The method of claim 7, wherein generating a plurality of approximate symbol estimates comprises:
(a) multiplying a matched filter output of a current subsymbol by a conjugate of a matched filter output of a subsequent subsymbol; and
(b) repeating step (a) for each subsymbol.

10. The method of claim 7, wherein generating a plurality of approximate symbol estimates comprises multiplying a symbol value of each subsymbol by a correction factor.

11. The method of claim 8, wherein generating a plurality of approximate symbol estimates comprises:
(a) multiplying a matched filter output of a current subsymbol by a conjugate of a matched filter output of a subsequent subsymbol; and
(b) repeating step (a) for each subsymbol.

12. The method of claim 8, wherein generating a plurality of approximate symbol estimates comprises multiplying a symbol value of each subsymbol by a correction factor.

13. An apparatus for processing a data symbol, comprising:
means for modulating the data symbol to produce a modulated data symbol;
means for encoding the modulated data symbol to generate an embedded offset in said modulated data symbol; and
means for transmitting the modulated data symbol with said embedded offset.

14. A computer-readable medium having stored thereon a plurality of instructions, the plurality of instructions including instructions which, when executed by a processor, cause the processor to perform the steps of a method for processing a data symbol, comprising:
modulating the data symbol to produce a modulated data symbol;
encoding the modulated data symbol to generate an embedded offset in said modulated data symbol; and
transmitting the modulated data symbol with said embedded offset.

15. An apparatus for demodulating a signal, comprising:
means for receiving a modulated signal having an embedded offset;
means for deriving a symbol estimate from the modulated signal; and
means for applying the symbol estimate to demodulate the modulated signal.

16. The apparatus of claim 15, further comprising:
means for removing the embedded offset from said symbol estimate; and
means for generating a new symbol estimate.

17. A computer-readable medium having stored thereon a plurality of instructions, the plurality of instructions including instructions which, when executed by a processor, cause the processor to perform the steps of a method for demodulating a signal, comprising:
receiving a modulated signal having an embedded offset;
deriving a symbol estimate from the modulated signal; and
applying the symbol estimate to demodulate the modulated signal.
